(19) United States
(12) Patent Application Publication
(10) Pub. No.: US 2018/0315441 A1
(43) Pub. Date: Nov. 1, 2018

(54) Loudness Assistance System

(71) Applicant: Jacksonville University, Jacksonville, FL (US)

(72) Inventors: Christine Sapienza, Jacksonville, FL (US); Huihui Wang, Jacksonville, FL (US)

(21) Appl. No.: 15/963,091

(22) Filed: Apr. 25, 2018

Related U.S. Application Data
(60) Provisional application No. 62/490,048, filed on Apr. 26, 2017.

(51) Int. Cl. G10L 25/48; G06F 3/16; G10L 25/78; G10L 21/0208

(52) U.S. Cl. CPC G10L 25/48; G06F 3/167; G10L 2025/783; G10L 21/0208; G10L 25/78

(57) ABSTRACT

The present disclosure provides generally for a wearable assistance device and software that may provide a measure of feedback to prompt a speaker to alter or change their vocal loudness as appropriate. According to the present disclosure, an assistance device may pair with other devices to facilitate, simplify, or amplify this feedback. The assistance device may also keep track of a speaker's progress, offer training and calibration modules, and learn when a speaker is more likely to need prompting. The assistance device may be part of a series of interchangeable assistance devices with similar functionality to be swapped out as needed by the speaker. The assistance devices may also have distance and situational awareness to alter its settings, either initiated by the speaker or on its own, to prompt a speaker appropriately.

### CROSS-REFERENCE TO RELATED APPLICATION

This application claims priority to and the full benefit of U.S. Provisional Patent Application Ser. No. 62/490,048, filed Apr. 26, 2017, and titled “LOUDNESS ASSISTANCE SYSTEM”, the entire contents of which are incorporated in this application by reference.

### BACKGROUND OF THE DISCLOSURE

Neurodegeneration refers to the progressive loss of neuron functionality or neuron structure, meaning a person's conditions continue and get worse over time. Currently, neurodegenerative diseases such as Parkinson's, Alzheimer's, Huntington's, and lateral sclerosis are incurable. These diseases involve the degeneration and loss of neuron cells on either or both a molecular or systemic level.

Parkinson's disease is the second most common neurodegenerative disorder, commonly diagnosed in late life. Approximately 1.5 million Americans live with Parkinson's disease, which is more than the number of people diagnosed with multiple sclerosis, muscular dystrophy, and Lou Gehrig's disease combined. About 60,000 Americans are diagnosed with Parkinson's disease each year, with many more going undiagnosed. There are more than 10 million people living with Parkinson's disease worldwide, and it is estimated that 1 in 6 people over 70 will be diagnosed with Parkinson's disease. The main symptoms related to Parkinson's include tremors, slow movement, and stiff muscles. These symptoms may start on one side of the body before progressing to the other side.

Other symptoms of Parkinson's disease are changes to voice and speech. A person may develop voice and speech problems, such as speaking softly, speaking quickly, slurring words, or hesitating before talking. A person's voice may also be more monotone instead of using inflections. One voice disorder that is very common is a low vocal loudness, often due to vocal fold bowing or respiratory weakness. Between 70-90% of those diagnosed with Parkinson's disease have speech and voice abnormalities related to their disease. This has widespread impact in their daily lives, with an increased sense of isolation due to not being able to properly interact with those around them. This may ultimately cause depression and have other mental or psychological effects.

People with Parkinson's disease then have to regularly work on articulation and rate of their speech. Speech therapy that is typically administered once or twice a week are relatively ineffective in treating these voice and speech disorders. Intensive speech treatment, meaning almost daily therapy, has shown favorable results. However, not everyone has access or the ability to attend daily therapy or can afford to pay privately when insurance-based benefits run out. Though there are several speech therapy treatments available, people diagnosed with Parkinson's disease need a common reminder to recalibrate how they speak, change the loudness they are speaking at, and to know when they are likely to speak at a higher or louder level. Approximately 7.5 million people in the United States have trouble using their voices, with disorders involving problems of pitch, loudness, and quality.

### SUMMARY OF THE DISCLOSURE

What is needed is a wearable assistance device that may provide a measure of feedback to prompt a speaker to alter or change their voice as appropriate. For example, a neurodegenerative disease, such as Parkinson's, may cause a user to unknowingly speak too softly, and an occupational side effect, such as from teaching or working in construction or on an aircraft, may cause a user to speak too loudly.

The assistance device may pair with other devices to facilitate, simplify, or amplify this feedback. The assistance device may also keep track of a person's progress, offer training modules, and learn when a person is speaking and in need prompting. The assistance device may be part of a series of interchangeable assistance devices with similar functionality to be swapped out as needed by the speaker. The assistance devices may also have distance and situational awareness to alter its settings, either initiated by the speaker or on its own, to prompt the speaker to take actions when appropriate. The assistance device must be calibrated, whether manually or automatically, to adapt or account for the noise in the speaker's immediate environment.

The present disclosure provides for a system of one or more computers that may be configured to perform particular operations or actions by virtue of having software, firmware, hardware, or a combination of them installed on the system that in operation causes or cause the system to perform the actions. In some embodiments, one or more computer programs can be configured to perform particular operations or actions by virtue of including instructions that, when executed by a data processing apparatus, cause the apparatus to perform the actions.

The present disclosure provides for a loudness assistance system comprising a primary loudness monitoring device configured to monitor speech of a user wearing the loudness monitoring device and collect primary speech data, where the primary loudness monitoring device may be programmable to detect a predefined minimum loudness, and a primary feedback device wirelessly coupled to the primary loudness monitoring device, where the primary loudness monitoring device may transmit detection data to the primary feedback device when a loudness below the predefined minimum loudness may be detected, and where the primary feedback device may send a first feedback to the user when the detection data may be received. In some aspects, the system may include corresponding computer systems, apparatus, and computer programs recorded on one or more computer storage devices, each configured to perform the actions of the methods.

In some implementations, a loudness assistance system may include a primary loudness monitoring device that may transmit detection data to the primary feedback device when a loudness above the predefined maximum loudness may be detected, and where the primary feedback device may send a second feedback to the user when the detection data may be received. In some aspects, a loudness assistance system may include one or both a primary loudness monitoring device and a primary feedback device that may be wearable. In some embodiments, a loudness assistance system may include a first feedback that may be continuous or intermittent until the loudness rises above a predefined minimum loudness.

In some implementations, a loudness assistance system may include a secondary loudness monitoring device configured to monitor speech of the user wearing the secondary loudness monitoring device and collect secondary speech data, where the secondary loudness monitoring device may be wirelessly connected to the primary loudness monitoring device, and where the secondary loudness monitoring device may include a second collection mechanism. In some embodiments, a comparison between the primary speech data and the secondary speech data may identify background noise and speech from the user. In some implementations, the primary loudness monitoring device may be configured to filter out background noise and monitor filtered loudness, and wherein the loudness may be based on the filtered loudness.

In some aspects, the first collection mechanism may be different from the second collection mechanism. In some embodiments, the first collection mechanism may include a microphone and the second collection mechanism may include a bone vibration monitoring device. In some implementations, the first feedback may include a haptic feedback. In some embodiments, the primary feedback device may send a second feedback. In some aspects, the second feedback may include a visual feedback. In some implementations, the second feedback may include an audio feedback.

In some embodiments, the loudness assistance system may comprise a secondary feedback device wirelessly coupled to the loudness monitoring device, where the loudness monitoring device may transmit detection data to the secondary feedback device when a loudness below a second minimum loudness device is detected, and where the secondary feedback device may send a secondary feedback to a second user when the detection data is received. In some implementations, the secondary feedback may be customizable. In some aspects, one or both the loudness monitoring device and the primary feedback device may be calibrated. In some embodiments, the calibration may establish a base loudness of the user.

In some aspects, one or both the loudness monitoring device and the primary feedback device may be coupled to an external device. In some embodiments, one or both the loudness monitoring device and the primary feedback device may be controllable by the external device. In some implementations, the external device may provide loudness exercises to the user, where the loudness exercises may be paired with one or both the loudness monitoring device and the primary feedback device.

### BRIEF DESCRIPTION OF THE DRAWINGS

The accompanying drawings, that are incorporated in and constitute a part of this specification, illustrate several embodiments of the disclosure and, together with the description, serve to explain the principles of the disclosure:

FIG. 1 illustrates an exemplary loudness assistance system, according to some embodiments of the present disclosure.

FIG. 2A illustrates an alternate exemplary loudness assistance system, according to some embodiments of the present disclosure.

FIG. 2B illustrates a side view of an exemplary loudness detection device.

FIG. 3A illustrates an exemplary application interface for calibration of a loudness assistance system, according to some embodiments of the present disclosure.

FIG. 3B illustrates an exemplary application interface for calibration of a loudness assistance system, according to some embodiments of the present disclosure.

FIG. 4A illustrates an exemplary application interface for a loudness assistance system, according to some embodiments of the present disclosure.

FIG. 4B illustrates exemplary conversation scenarios that may apply to a loudness assistance system, according to some embodiments of the present disclosure.

FIG. 4C illustrates exemplary conversation scenarios that may apply to a loudness assistance system, according to some embodiments of the present disclosure.

FIG. 4D illustrates exemplary conversation scenarios that may apply to a loudness assistance system, according to some embodiments of the present disclosure.

FIG. 5 illustrates an exemplary application interface for monitoring progress of a loudness assistance system, according to some embodiments of the present disclosure.

FIG. 6 illustrates an exemplary calibration graphical user interface (GUI), according to some embodiments of the present disclosure.

FIG. 7 illustrates an exemplary calibration graphical user interface (GUI), according to some embodiments of the present disclosure.

FIG. 8 illustrates exemplary method steps for monitoring loudness of a user, according to some embodiments of the present disclosure.

FIG. 9 illustrates an exemplary apparatus that may be used to implement aspects of the present disclosure including executable software.

FIG. 10 illustrates an exemplary network system that may be used to implement aspects of the present disclosure.

FIG. 11 illustrates an exemplary cyber physical healthcare system that may be used to implement aspects of the present disclosure.

### DETAILED DESCRIPTION

The present disclosure provides generally for a wearable assistance device that may provide a measure of feedback to prompt a speaker to alter or change their vocal loudness as appropriate. According to the present disclosure, the assistance device may pair with other devices to facilitate, simplify, or amplify this feedback. The assistance device may also keep track of a speaker's progress, offer training modules, and learn when a speaker is more likely to need prompting. The assistance device may be part of a series of interchangeable assistance devices with similar functionality to be swapped out as needed by the speaker. The assistance devices may also have distance and situational awareness to alter its settings, either initiated by the speaker or on its own, to prompt the speaker to take actions when appropriate.

In the following sections, detailed descriptions of examples and methods of the disclosure will be given. The description of both preferred and alternative examples, though thorough, are exemplary only, and it is understood that to those skilled in the art variations, modifications, and alterations may be apparent. It is therefore to be understood that the examples do not limit the broadness of the aspects of the underlying disclosure as defined by the claims.

### Glossary

Loudness Monitor Device: as used herein refers to a device or family of interchangeable devices configured to monitor and recognize decibel levels and the fundamental frequency in the speech of a user. In some aspects, the loudness detection device may directly monitor speech, such as through a microphone. In some implementations, the loudness detection device may discern vocal loudness through indirect monitoring, such as monitoring vibration levels through bone conduction, as a non-limiting example. In some aspects, the loudness detection device may combine the above to create a more accurate profile of the environment to detect speech and filter independent speakers.
Feedback Device: as used herein refers to a device that may provide feedback based on received data from a loudness detection device. In some aspects, the feedback device may comprise a wearable device that may wirelessly receive loudness data from the loudness detection device. The feedback type may comprise haptic, audio, visual, or combinations thereof.
Loudness Assistance System: as used herein refers to a system for monitoring loudness of a user and providing feedback based on the monitored loudness data as well as the fundamental frequency.

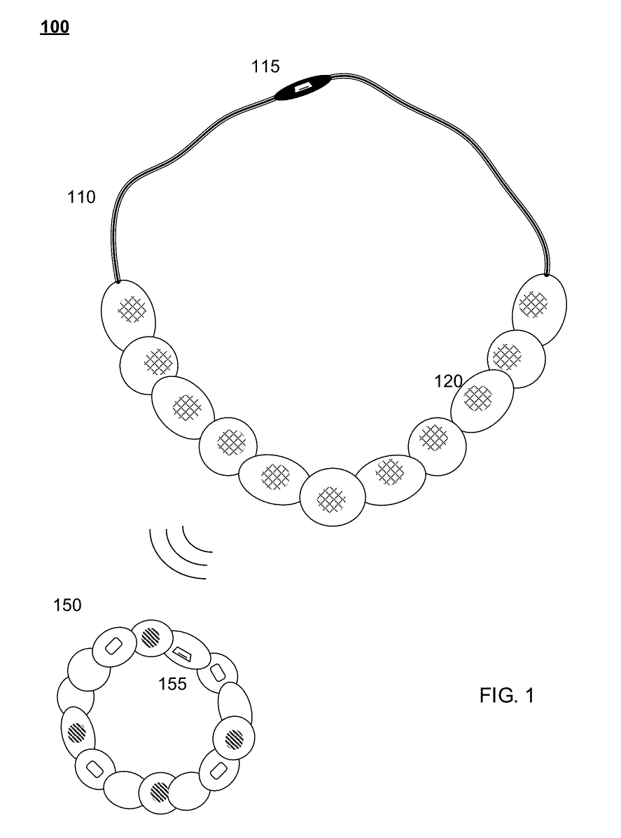

Referring now to FIG. 1, an exemplary loudness assistance system 100 comprising a loudness monitor device 110 and a feedback device 150 is illustrated. In some aspects, a loudness monitor device 110 may comprise a necklace, and the feedback device 150 may comprise a paired bracelet, which may provide feedback to a user based on the detected loudness. The feedback may comprise haptic feedback, such as a vibration; visual, such as lighting or images on an interface; or auditory, such as a beep or sound clip. In some embodiments, the feedback may be customizable, wherein a user may select their preferred feedback. The selected feedback may comprise one or more of the feedback options. For example, a user may select both visual and haptic feedback.

In some aspects, a loudness monitor device 110 may comprise a single, unidirectional microphone in a centered position, such as a pendant design. The distance between the microphone and the mouth of the speaker may be adjusted during calibration, wherein calibration may prompt a user to change the length of the necklace until the detected speech range falls within predefined acceptable parameters.

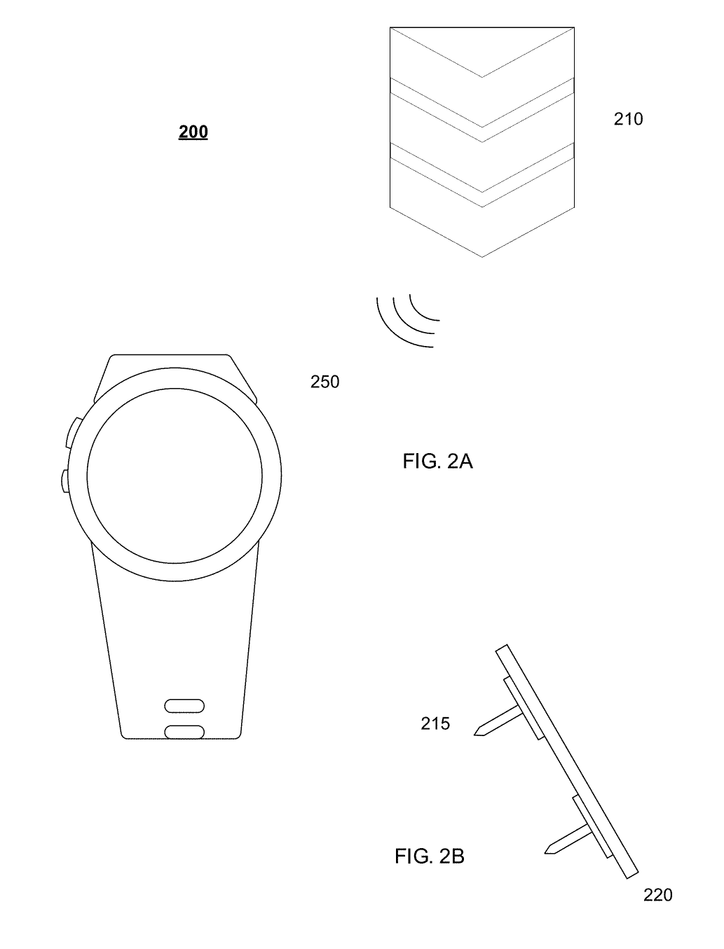

In some embodiments, the loudness assistance system 100 may be programmable to one or more a base threshold, maximum threshold, and minimum threshold. Where speech exceeds a maximum decibel (dB) sound pressure level (SPL) threshold, the user may receive feedback that they are speaking too loudly. Where speech falls below a minimum dB SPL threshold, the user may be prompted to speak more loudly. Where speech falls below a dB SPL base threshold, the loudness assistance system 100 may not recognize the speech. In some aspects, the loudness assistance system 100 may comprise a secondary feedback device (not shown) similar to the one described in FIG. 2 below.

In some implementations, one or both the designs of the loudness monitor device 100 and the feedback device 150 may be customizable. For example, the feedback device 150 may comprise a charm bracelet that may allow for interchangeable charms, wherein the chain portion may comprise the feedback mechanism. As another example, a pendant or locket design for the loudness monitor device 100 may have a sleeve or pocket, wherein a user may insert different pendant faces or photos to suit their aesthetic preferences.

In some aspects, the loudness assistance system 100 may comprise a secondary feedback device (not shown) that may notify another person that the user may be speaking. The secondary feedback device may comprise another wearable, such as a pin or bracelet, which may be worn by a caretaker, such as a spouse, nurse, or friend. In some implementations, the secondary feedback device may comprise a portable device that may be placed in a visible or audible area, such as a counter or bookshelf, wherein the secondary feedback device may notify anyone who can see or hear the secondary feedback device. A portable version may allow anyone in the household to respond to the user without limiting the device to a single caretaker.

In some embodiments, one or both the loudness monitor device 110 and the feedback device 150 may be rechargeable, such as through a micro-USB port 115, 155, conductive charging, solar charging, or other charging mechanisms. In some aspects, the loudness monitors and feedback devices may be interchangeable, wherein a user may switch out the loudness monitors and feedback devices based on preference. For example, a user may choose the loudness monitors and feedback devices daily based on their attire or the occasion.

In some aspects, a loudness monitor device 110 may comprise an array of unidirectional microphones 120. An array of microphones 120 may monitor loudness consistently even as a user may turn her head. A single unidirectional microphone may effectively detect speech from a user. In some embodiments, the system may adjust the perceived volume to compensate for speech that may occur directionally away from the microphone.

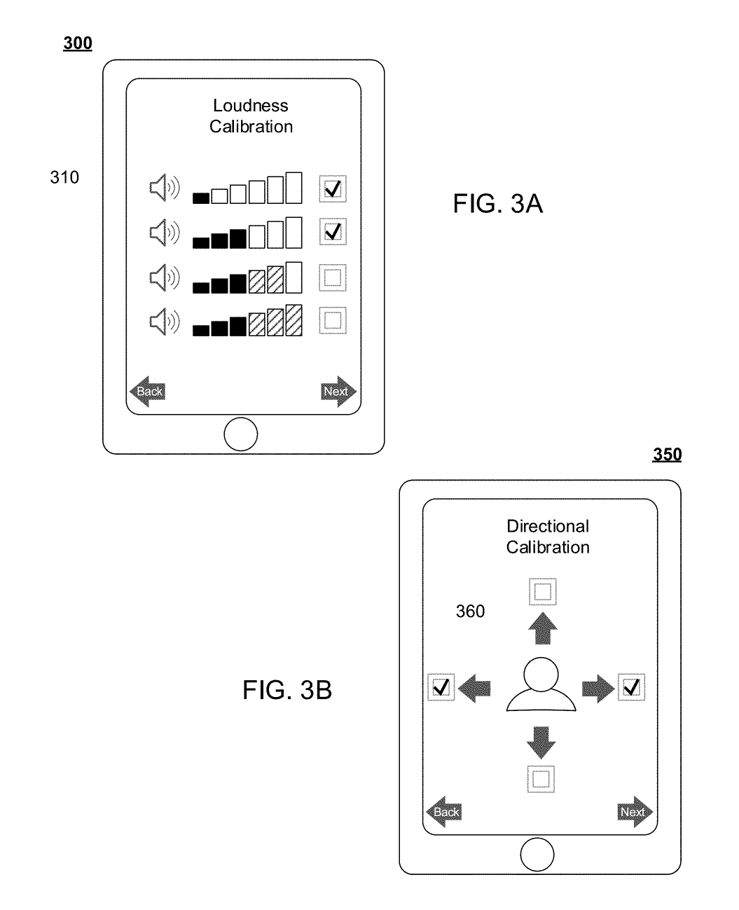

In some implementations, a loudness monitor device 110 may comprise low power pressure sensors throughout the necklace. For example, where the loudness monitor device 110 may comprise a microphone array 120, a user may selectively activate portions of the array, which may conserve power and allow for more accurate loudness detection. As another example, a user may trigger a pressure sensor, and the system may compensate for indirect speech. The compensation may be based on average differences in loudness depending on directionality of the speech. In some implementations, the compensation may be based on calibrations for an individual user, such as illustrated in FIGS. 3A-3B. In some embodiments, there may be a separate paired device, such as a smart phone, laptop, or desktop computer, used for offloading calculations, storing data, or to access progress or program visualizations.

Referring now to FIGS. 2A-2B, an alternate exemplary loudness assistance system 200 with a loudness monitor device 210 and feedback device 250 is illustrated, wherein the loudness monitor device 210 may comprise a pin and the feedback device 250 may comprise a watch. In some aspects, the loudness monitor device 210 may comprise an attachment mechanism 215 and a sensor plate 220, which may comprise a unidirectional microphone. In some embodiments, the feedback device 250 may provide a range of functionality, such as an analog watch, digital watch, or smartwatch equipped with a plurality of applications.

In some implementations, there may be more than one loudness monitor device 210 to more effectively capture sound, wherein a second loudness monitor device 210 may allow for noise filtering. In some aspects, a loudness monitor device 210 may be placed in front of a speaker, such as pointing towards them as they sit at a restaurant, to effectively capture sound. In some embodiments, a second loudness monitor device 210 may monitor loudness through bone vibration or conduction and may be located proximate to or in contact with a user's breast, throat, or another appropriate monitoring location. In some implementations, the noise and loudness detected through bone vibration or conduction may be compared to the noise and loudness detected through a different monitoring means, such as a microphone, wherein signal processing through a comparative circuit may effectively filter out background noise.

In some embodiments, a loudness assistance system 200 may comprise a secondary feedback device 250, which may receive loudness data from the loudness monitor device 210. For example, a caretaker may want to know when their patient is trying to speak. The secondary feedback device 250 may be worn or held by the caretaker who may receive the feedback from the loudness monitor device 250 from a distance, such as a different room or across the room. In some aspects, the loudness assistance system 200 may comprise more than one wireless communication mechanisms, such as Bluetooth, near radio frequency, or infrared, as non-limiting examples.

Referring now to FIG. 3A-3B, exemplary application interfaces 300, 350 for calibration of a loudness assistance system are illustrated. In some embodiments, a user may calibrate a loudness assistance system. The calibration may occur once, such as when a user first operates the loudness assistance system. In some aspects, the calibration may occur periodically, such as daily before use, after charging one or both the loudness monitor device or the feedback device, or when entering a different noise environment.

In some embodiments, the calibration may comprise multiple steps, wherein each calibration step may allow for more precise monitoring of loudness. A loudness calibration interface 300 may prompt a user to speak to a series of predefined loudness level 310, which may ensure that the loudness monitor effectively registered the user's loudness range and may allow a user to recognize how certain loudness may feel. In some implementations, a directional calibration interface 350 may prompt a user to speak at a range of head positions 360, which may allow the loudness assistance system to adapt threshold levels based on direction of the speech.

In some embodiments, the loudness assistance system may comprise one or both secondary feedback mechanisms or adaptive feedback mechanisms. In some implementations, the feedback mechanism may originally provide the programmed feedback type. Where the user may not adequately compensate to the maximum or minimum threshold level, the sustained feedback may not be perceived. In some aspects, the feedback method may adapt until the user responds. For example, the feedback may cycle through different vibration patterns or intensities or types, such as haptic, visual, or audio.

In some embodiments, the loudness assistance system may transmit a notification to a secondary device, such as the cell phone of the user or a healthcare provider, which may alert one or both the user and healthcare provider that the feedback is not effective. In some aspects, the duration of the feedback may be tracked and stored, wherein duration patterns may indicate the effectiveness of the feedback and the abilities of the user to adapt. In some implementations, other functionality may be integrated into the loudness assistance system. For example, other symptoms may be monitored associated with a disorder or general functionality such as fall alerts or step counting.

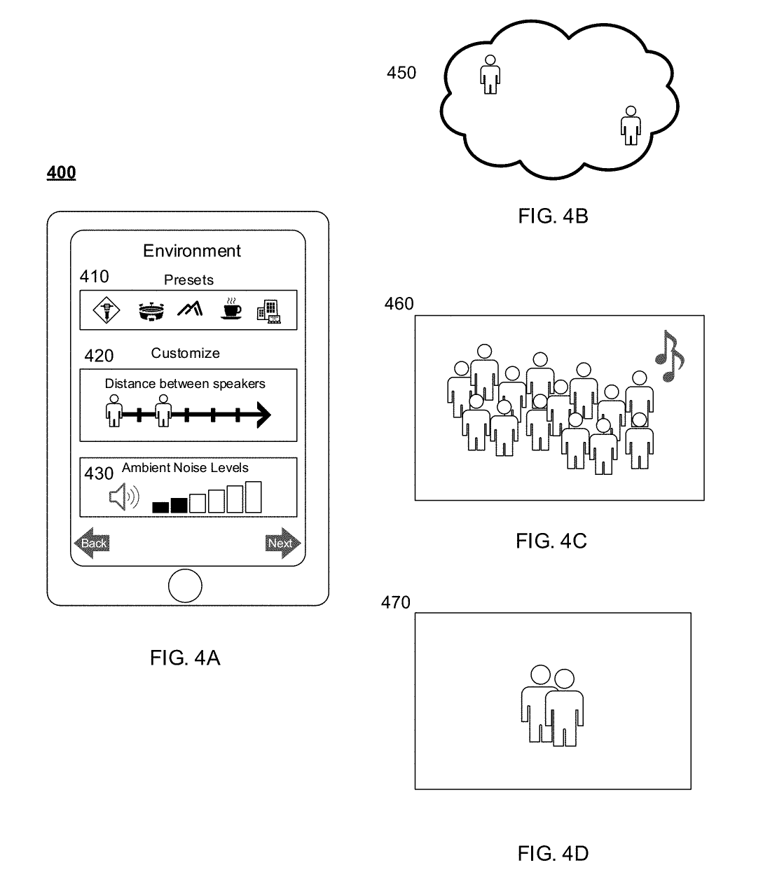

Referring now to FIGS. 4A-4D, an exemplary application interface 400 for programming a loudness assistance system is illustrated. In some aspects, a user may input environment settings for a loudness assistance system. In some embodiments, a user may select environment conditions, which may prompt changes in one or both the monitoring or the feedback. The exemplary application interface 400 may present an option to select a general distance between speakers 420 or ambient noise levels 430. In some implementations, the application interface 400 may present preset options 410, which may be predefined based on environment conditions typical of the preset scenarios.

In some aspects, environment conditions may be monitored, such as through an ambient loudness monitor on one or both the loudness monitor device or feedback device. In some embodiments, environment condition profiles may be preprogrammed based on typical weekly activities, such as loud working conditions Monday through Friday and quiet but open conditions on Saturday during weekly bird watching.

For example, as illustrated in FIG. 4B, in an open scenario 450, a user may be in an open, outdoor setting speaking with someone from a distance. Hiking, camping, or general outdoor exploration may comprise presets for an open scenario 450. In some implementations, an open scenario 450 may require a higher threshold for a user to be heard, and may not affect feedback type.

As another example, as illustrated in FIG. 4C, in a crowded scenario 460, a user may be in an enclosed area, packed with people, and possibly an additional source of noise, such as music or din. A dance club, concert, cocktail party, or sporting event may comprise presets for a crowded scenario 460, as non-limiting examples. In some aspects, a crowded scenario 460 may require a higher threshold for the user to be heard, and more intense tactile feedback.

As still another example, as illustrated in FIG. 4D, in an intimate scenario 470, a user may be speaking to a person close by in a quiet environment. A dinner date or coffee meeting may comprise presets for an intimate scenario 470, as non-limiting examples. In some embodiments, an intimate scenario 470 may allow for a lower loudness threshold, and more subtle feedback.

As another example, a preset may comprise a phone call mode, which may simulate the conditions and decibel requirements for a conversation through a phone. In some aspects, the loudness monitor device may recognize when a speaker is making a phone call. The loudness monitor device may shift the monitoring to the microphone in the phone, such as where the loudness assistance system may be paired with the phone.

In some implementations, the feedback may vary based on predefined conditions, such as ambient noise levels, ambient light levels, time of day, or other detectable conditions. The predefined conditions may be preprogrammed into the system during manufacturing, by a user, by a speech therapist or pathologist, by a retailer, or any combination thereof. For example, the default settings may utilize haptic feedback during the day and visual feedback at night, such as lighting. A user may program the settings to accommodate for their schedule. For example, a user may work at night in a place with ample lighting, and a visual cue may be lost in the environment. The user may program the device to provide haptic feedback.

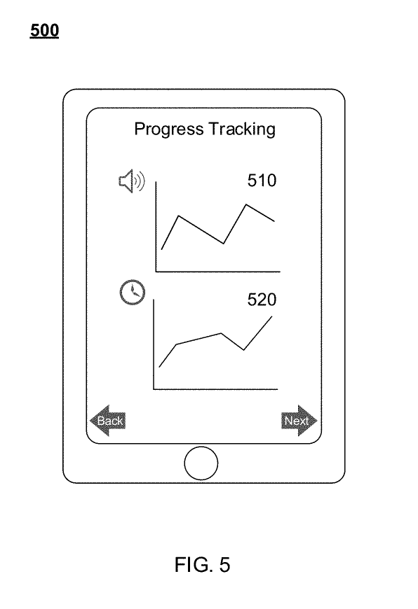

Referring now to FIG. 5, an exemplary application interface 500 for reviewing speech progress in conjunction with a loudness assistance system is illustrated. In some aspects, a user or their healthcare provider may want to review progress or trends in the monitored data. In some embodiments, the application interface may provide graphical representations of a number of alerts sent based on noise conditions 510 or time of day 520. For example, a user may want to know under what noise conditions or time of day they have the most issues with loudness. In some aspects, the number of alerts throughout the day may fluctuate based on a range of factors, including, for example, changes in ambient conditions, energy levels of a user, or activities, as non-limiting examples.

An increase in alerts may indicate that a user is not responding to the feedback. This may occur because the user is physically exhausted and unable to adjust. Non-responsiveness may occur because the feedback is too subtle to be noticed. In some embodiments, a feedback device may be programmed to cycle through feedback settings if an initial feedback is seemingly ignored by a user. For example, a visual cue may go unnoticed, so the feedback is changed to haptic feedback that may increase in intensity until the user sufficiently increases their loudness.

In some implementations, the trends may be adapted into profiles, which may be manually or automatically adapted. For example, weekly trends may emerge based on a user's schedule. In some aspects, the loudness assistance system may identify the trend and prompt a user to accept the profile. In some embodiments, the loudness assistance system may adapt over time, learning trends for a particular user, which may be overridden manually by the user.

In some embodiments, the loudness assistance system may be paired with therapy exercises that may allow a user to train without requiring a visit to a healthcare provider. For example, a user may practice reaching and sustaining a particular decibel level. As another example, a user may be prompted to read a passage of text at one or more decibel levels. In some aspects, a therapist or healthcare provider may develop training programs for their patients, allowing users to continue their therapy between visits.

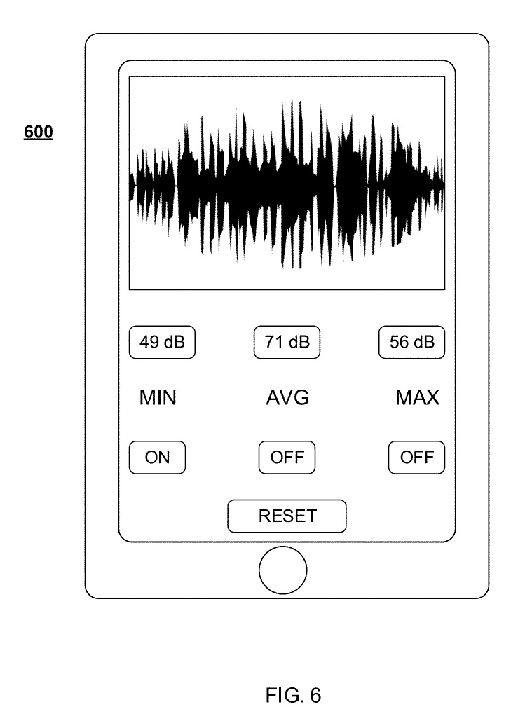

Referring now to FIG. 6, an exemplary portable device calibration graphical user interface (GUI) 600 is illustrated. In some aspects, a portable device calibration GUI 600 may prompt a user to speak for a predefined amount of time in a conversational tone and volume, wherein the portable device calibration GUI 600 may identify the minimum, maximum, and average loudness throughout the calibration set. In some implementations, a user may be able to toggle what aspects of the user's loudness may be monitored, wherein the user may receive notifications based on the selected aspects.

For example, a user may select a minimum loudness, and the feedback device may be activated when the user's loudness falls below the minimum threshold. As another example, the user may select both a minimum and maximum loudness, wherein the feedback may be received when loudness below the minimum and loudness above the maximum may be detected. In some embodiments, the feedback may be different for maximum and minimum notifications, which may allow the user to adjust their loudness accordingly.

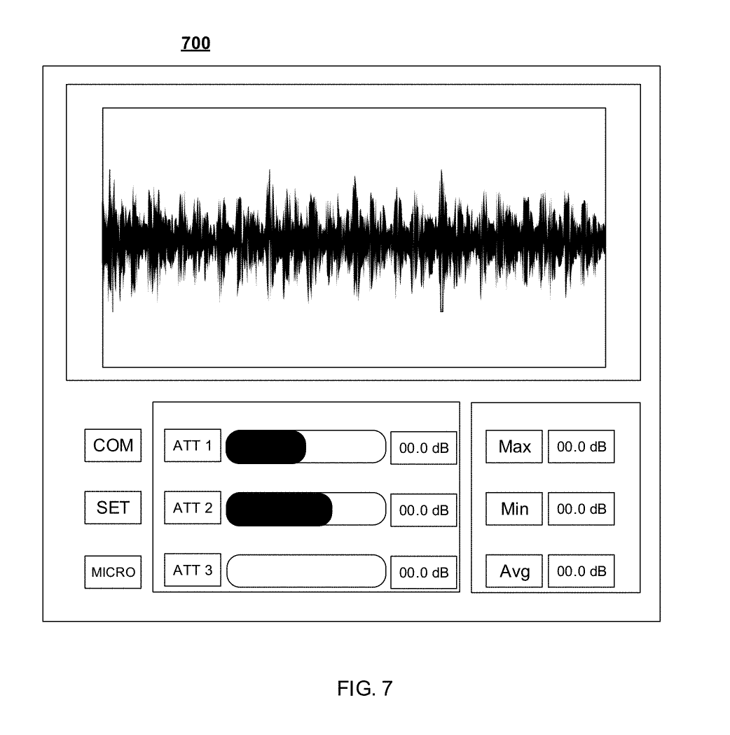

Referring now to FIG. 7, an exemplary calibration graphical user interface (GUI) 700 is illustrated. In some aspects, the calibration GUI 700 may be accessible by a third party, such as a caretaker, doctor, or other healthcare provider. In some embodiments, a calibration GUI 700 may allow for remote monitoring of the loudness of the user. In some aspects, a calibration GUI 700 may allow a third party to remotely interact with the user during calibration.

For example, a user may not be able to travel to a healthcare provider for therapy, and it may be useful for a healthcare provider to periodically validate the calibration to ensure the user is properly utilizing the loudness assistance system. The healthcare provider may be able to log into a calibration GUI 700 and manually prompt the user to speak for the calibration. As another example, a speech therapist may want to vary the calibration parameters to increase the effectiveness of the loudness assistance system, as over time a user may change their average loudness. If the average loudness drops below an audible level, the loudness assistance system may not effectively help the user.

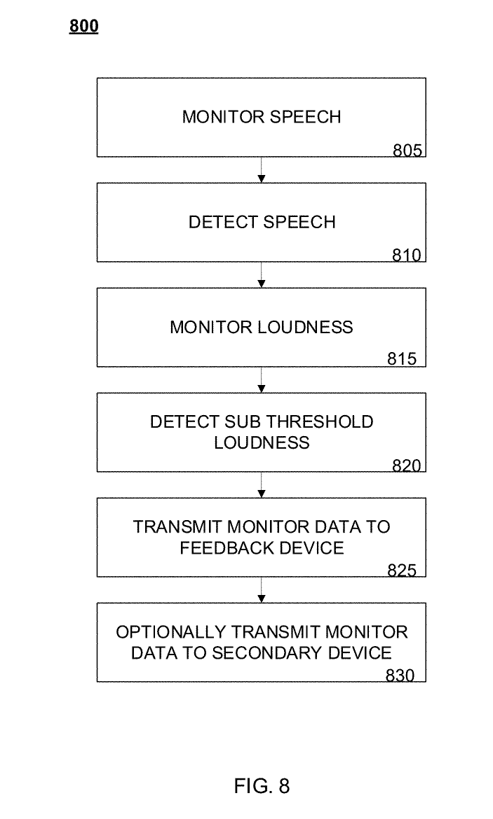

Referring now to FIG. 8, exemplary method steps 800 for monitoring loudness of a user are illustrated. At 805, the speech of a user may be monitored, wherein the monitoring may recognize whether a user is speaking. At 810, speech may be detected, and at 815, the detected speech may be monitored for loudness, fundamental frequency, harmonic frequencies, or a combination of these as needed or configured. At 820, sub-threshold loudness of speech may be detected, and at 825, the monitor data may be transmitted to a feedback device. In some aspects, at 830, the monitor data may be transmitted to a secondary device, such as a smartphone, tablet, laptop, or healthcare provider apparatus.

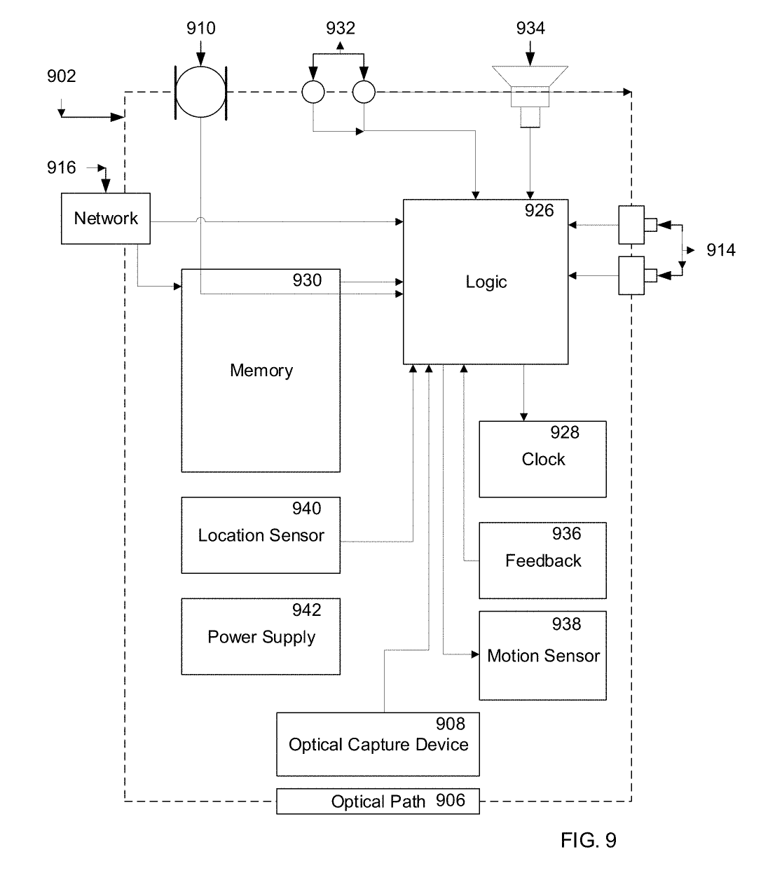

Referring now to FIG. 9, an exemplary block diagram of an exemplary embodiment of a mobile device 902 is illustrated. The mobile device 902 may comprise an optical capture device 908, which may capture an image and convert it to machine-compatible data, and an optical path 906, typically a lens, an aperture, or an image conduit to convey the image from the rendered document to the optical capture device 908. The optical capture device 908 may incorporate a Charge-Coupled Device (CCD), a Complementary Metal Oxide Semiconductor (CMOS) imaging device, or an optical sensor of another type.

In some embodiments, the mobile device 902 may comprise a microphone 910, wherein the microphone 910 and associated circuitry may convert the sound of the environment, including spoken words, into machine-compatible signals. Input facilities 914 may exist in the form of buttons, scroll-wheels, or other tactile sensors such as touch-pads. In some embodiments, input facilities 914 may include a touchscreen display. Visual feedback 932 to the user may occur through a visual display, touchscreen display, or indicator lights. Audible feedback 934 may be transmitted through a loudspeaker or other audio transducer. Tactile feedback may be provided through a vibration module 936.

In some aspects, the mobile device 902 may comprise a motion sensor 938, wherein the motion sensor 938 and associated circuitry may convert the motion of the mobile device 902 into machine-compatible signals. For example, the motion sensor 938 may comprise an accelerometer, which may be used to sense measurable physical acceleration, orientation, vibration, and other movements. In some embodiments, the motion sensor 938 may comprise a gyroscope or other device to sense different motions.

In some implementations, the mobile device 902 may comprise a location sensor 940, wherein the location sensor 940 and associated circuitry may be used to determine the location of the device. The location sensor 940 may detect Global Position System (GPS) radio signals from satellites or may also use assisted GPS where the mobile device may use a cellular network to decrease the time necessary to determine location. In some embodiments, the location sensor 940 may use radio waves to determine the distance from known radio sources such as cellular towers to determine the location of the mobile device 902. In some embodiments these radio signals may be used in addition to and/or in conjunction with GPS.

In some aspects, the mobile device 902 may comprise a logic module 926, which may place the components of the mobile device 902 into electrical and logical communication. The electrical and logical communication may allow the components to interact. Accordingly, in some embodiments, the received signals from the components may be processed into different formats and/or interpretations to allow for the logical communication. The logic module 926 may be operable to read and write data and program instructions stored in associated storage 930, such as RAM, ROM, flash, or other suitable memory. In some aspects, the logic module 926 may read a time signal from the clock unit 928. In some embodiments, the mobile device 902 may comprise an on-board power supply 942. In some embodiments, the mobile device 902 may be powered from a tethered connection to another device, such as a Universal Serial Bus (USB) connection.

In some implementations, the mobile device 902 may comprise a network interface 916, which may allow the mobile device 902 to communicate and/or receive data to a network and/or an associated computing device. The network interface 916 may provide two-way data communication. For example, the network interface 916 may operate according to an internet protocol. As another example, the network interface 916 may comprise a local area network (LAN) card, which may allow a data communication connection to a compatible LAN. As another example, the network interface 916 may comprise a cellular antenna and associated circuitry, which may allow the mobile device to communicate over standard wireless data communication networks. In some implementations, the network interface 916 may comprise a Universal Serial Bus (USB) to supply power or transmit data. In some embodiments, other wireless links known to those skilled in the art may also be implemented.

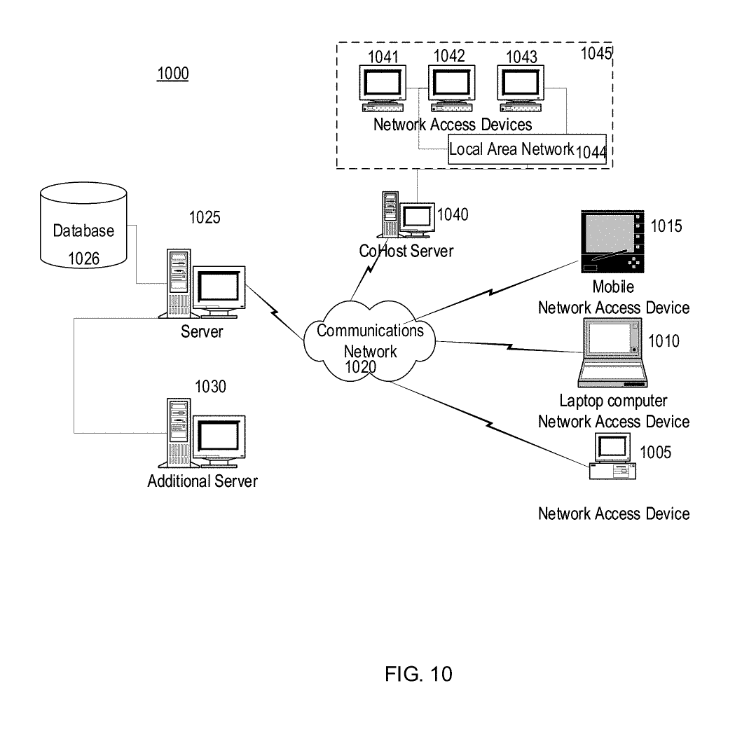

Referring now to FIG. 10, an exemplary processing and interface system 1000 is illustrated. In some aspects, access devices 1015, 1010, 1005, such as a paired portable device 1015 or laptop computer 1010 may be able to communicate with an external server 1025 though a communications network 1020. The external server 1025 may be in logical communication with a database 1026, which may comprise data related to identification information and associated profile information. In some embodiments, the server 1025 may be in logical communication with an additional server 1030, which may comprise supplemental processing capabilities.

In some aspects, the server 1025 and access devices 1005, 1010, 1015 may be able to communicate with a cohost server 1040 through a communications network 1020. The cohost server 1040 may be in logical communication with an internal network 1045 comprising network access devices 1041, 1042, 1043 and a local area network 1044. For example, the cohost server 1040 may comprise a payment service, such as PayPal or a social network, such as Facebook or a dating website.

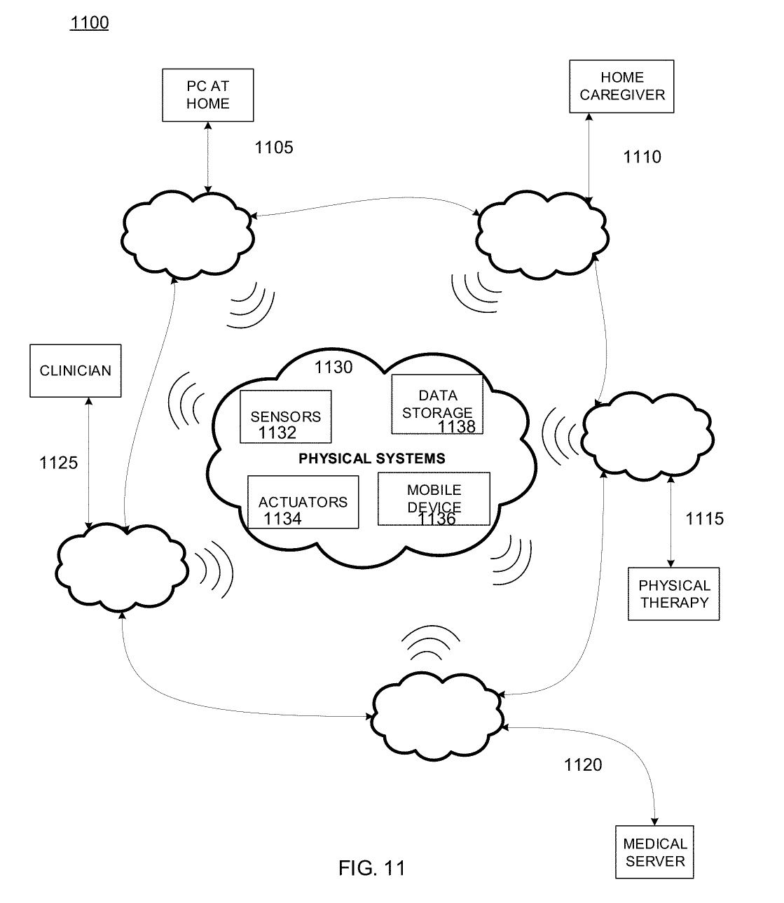

Referring now to FIG. 11, an exemplary cyber physical healthcare system 1100 is illustrated. In some aspects, data may be collected and stored by one or more independent servers, such as by a home computer 1105, home caregiver 1110, physical therapist 1115, medical provider 1120, or clinician 1125, as non-limiting examples. The collected and stored data may exchange data with physical systems, such as sensors 1132, actuators 1134, mobile devices 1136, and personal data storage 1138, as non-limiting examples.

In some aspects, personal data storage 1138 may be located on a wearable or portable device that may collect data directly from the sensor mechanisms on the wearable or portable device. In some embodiments, the data exchanged between the physical systems and cyber systems may utilize one or more wireless communication systems and wired systems. In some implementations, data may be exchanged between cyber systems, such as between a clinician 1125 and physical therapist 1115.

As an illustrative example, a home computer 1105 and home caregiver 1110 may collect daily information from at least a portion of the physical systems 1130, such as a loudness assistance system as described in FIG. 1. The collected data may be transferred to a clinician 1125, physical therapist 1115, or medical provider 1120 periodically, such as prior to scheduled visits. Similarly, the clinician 1125, physical therapist 1115, and medical provider 1120 may exchange data about a patient as necessary.

### CONCLUSION

A number of embodiments of the present disclosure have been described. While this specification contains many specific implementation details, these should not be construed as limitations on the scope of any disclosures or of what may be claimed, but rather as descriptions of features specific to particular embodiments of the present disclosure.

Certain features that are described in this specification in the context of separate embodiments can also be implemented in combination or in a single embodiment. Conversely, various features that are described in the context of a single embodiment can also be implemented in combination in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous.

Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order show, or sequential order, to achieve desirable results. In certain implementations, multitasking and parallel processing may be advantageous. Nevertheless, it will be understood that various modifications may be made without departing from the spirit and scope of the claimed disclosure.

What is claimed is:

1. A loudness assistance system comprising:
a primary loudness monitoring device configured to monitor speech of a user wearing the loudness monitoring device and collect primary speech data, wherein the primary loudness monitoring device is programmable to detect a predefined minimum loudness; and
a primary feedback device wirelessly coupled to the primary loudness monitoring device, wherein the primary loudness monitoring device transmits detection data to the primary feedback device when a loudness below the predefined minimum loudness is detected, and wherein the primary feedback device sends a first feedback to the user when the detection data is received.

2. The loudness assistance system of claim 1, wherein the primary loudness monitoring device transmits detection data to the primary feedback device when a loudness above a predefined maximum loudness is detected, and wherein the primary feedback device sends a second feedback to the user when the detection data is received.

3. The loudness assistance system of claim 1, wherein one or both the primary loudness monitoring device and the primary feedback device are wearable.

4. The loudness assistance system of claim 1, wherein the first feedback is continuous or intermittent until the loudness rises above the predefined minimum loudness.

5. The loudness assistance system of claim 1, further comprising a secondary loudness monitoring device configured to monitor speech of the user wearing the secondary loudness monitoring device and collect secondary speech data, wherein the secondary loudness monitoring device is wirelessly connected to the primary loudness monitoring device, and wherein the primary loudness monitoring device comprises a first collection mechanism and the secondary loudness monitoring device comprises a second collection mechanism.

6. The loudness assistance system of claim 5, wherein a comparison between the primary speech data and the secondary speech data identifies background noise and speech from the user.

7. The loudness assistance system of claim 6, wherein the primary loudness monitoring device is configured to filter out background noise and monitor filtered loudness, and wherein the loudness is based on the filtered loudness.

8. The loudness assistance system of claim 5, wherein the first collection mechanism is different from the second collection mechanism.

9. The loudness assistance system of claim 8, wherein the first collection mechanism comprises a microphone and the second collection mechanism comprises a bone vibration monitoring device.

10. The loudness assistance system of claim 1, wherein the first feedback comprises a haptic feedback.

11. The loudness assistance system of claim 10, wherein the primary feedback device sends a second feedback.

12. The loudness assistance system of claim 11, wherein the second feedback comprises a visual feedback.

13. The loudness assistance system of claim 11, wherein the second feedback comprises an audio feedback.

14. The loudness assistance system of claim 1 further comprising a secondary feedback device wirelessly coupled to the loudness monitoring device, wherein the loudness monitoring device transmits detection data to the secondary feedback device when a loudness below a second minimum loudness device is detected, and wherein the secondary feedback device sends a secondary feedback to a second user when the detection data is received.

15. The loudness assistance system of claim 14, wherein the secondary feedback is customizable.

16. The loudness assistance system of claim 1, wherein one or both the loudness monitoring device and the primary feedback device can be calibrated.

17. The loudness assistance system of claim 16, wherein a calibration establishes a base loudness of the user.

18. The loudness assistance system of claim 1, wherein one or both the loudness monitoring device and the primary feedback device are coupled to an external device.

19. The loudness assistance system of claim 18, wherein one or both the loudness monitoring device and the primary feedback device are controllable by the external device.

20. The loudness assistance system of claim 19, wherein the external device provides loudness exercises to the user, wherein the loudness exercises are paired with one or both the loudness monitoring device and the primary feedback device.
